(19) United States
(12) Patent Application Publication
(10) Pub. No.: US 2023/0130624 A1
(43) Pub. Date: Apr. 27, 2023

(54) SECURE COMPUTATION SYSTEM, SECURE COMPUTATION SERVER APPARATUS, SECURECOMPUTATION METHOD, AND SECURE COMPUTATION PROGRAM

(71) Applicant: NEC Corporation, Minato-ku, Tokyo (JP)

(72) Inventor: Hikaru TSUCHIDA, Tokyo (JP)

(73) Assignee: NEC Corporation, Minato-ku, Tokyo (JP)

(21) Appl. No.: 17/910,403

(22) PCT Filed: Mar. 24, 2020
(86) PCT No.: PCT/JP2020/012906

§ 371 Date: Sep. 9, 2022

(51) Int. Cl. G06F 21/60; H04L 9/08

(52) U.S. Cl. CPC G06F 21/602; H04L 9/085; H04L 2209/46

(57) ABSTRACT

Each of the secure computation server apparatuses includes a bit-decomposition operation part that performs a bit-decomposition for a share value secretly shared with a constant number of rounds; a table operation part that determines a success or failure of an equality at each bit of the bit-decomposition using a table in which determination expressions for determination whether or not the equality holds at each bit are arranged in a row direction, and combinations of the determination expressions are arranged in a column direction; and an equality determination part that performs equality determination with a constant number of rounds for a value that accumulates a result of the success or failure of the equality at each bit of the bit-decomposition to determine an array reference corresponding to the share value.

### TECHNICAL FIELD

The present invention relates to a secure computation system, a secure computation server apparatus, a secure computation method, and a secure computation program.

### BACKGROUND ART

In recent years, research and development referred to as a secure computation have been actively carried out. The secure computation is a technique for performing a predetermined processing while concealing an input value and a value of computation processes from a third party. As one of a typical technique for realizing the secure computation, a Multi-Party Computation technique is known. According to the Multi-Party Computation technique, secure data are distributedly arranged [i. e. shared] at multiple servers (secure computation servers), and arbitrary operations can be performed while keeping the data secure. Hereinafter, unless otherwise noted, the term “secure computation” means “Multi-Party Computation technique”.

There is an array reference, as one of a processing for realizing the secure computation. The array reference is a processing for referencing elements stored in arrays. In some cases, the array reference in the secure computation may require that even an index indicating where to refer to is kept secret. As a sub-protocol used for the array reference that keeps the index secret, there is a Demux (demultiplexer) protocol (for example, see Non-Patent Literature (NPL) 1). The Demux protocol in the secure computation is a processing that takes a secure index as input and computes, in secret, an output that only an element of the array corresponding to the input index is 1 and other elements are 0.

### CITATION LIST

### Non Patent Literature

NPL1: J. Launchbury et al. Efficient Lookup-Table Protocol in Secure Multiparty Computation. In ICFP 2012.
NPL2: Catrina, Octavian. Round-efficient protocols for secure multiparty fixed-point arithmetic. 2018 International Conference on Communications (COMM). IEEE, 2018.

### SUMMARY

### Technical Problem

Each disclosure of the above literatures of Citation List is to be incorporated herein by reference thereto. The following analysis is given by the present inventor.

By the way, in the secure computation using the Multi-Party Computation technique, the processing is performed in a state where secure data is distributed across multiple servers, which makes reducing a communication cost an issue in terms of processing efficiency. The communication cost can be broken down into a communication traffic (volume), which represents an amount of data to be communicated, and a number of communication rounds, which represents the number of communication rounds when the maximum possible parallelization is performed.

While there is often a trade-off between the communication traffic (volume) and the number of rounds, there is also a case where the priority should be given to either the communication traffic (volume) or the number of rounds, depending on an environment. For example, in an environment where communication latency is large, such as a Wide Area Network (WAN) environment, a smaller number of communication rounds is more advantageous, and thus the secure computation with a smaller number of communication rounds is preferable. For example, in the Demux protocol disclosed in NPL 1, the order of the number of communication rounds is O(log₂ k). If the Demux protocol with the number of communication rounds being a constant number is realized, the communication cost can be reduced in an environment with large communication latency, etc.

It is an object of the present invention to provide a secure computation system, a secure computation server apparatus, a secure computation method, and a secret calculation program, which contribute to reducing the number of communication rounds in view of above circumstance.

### Solution to Problem

According to a first aspect of the present invention, there is provided a secure computation system, including at least three or more secure computation server apparatuses connected to each other through a network, wherein

each of the secure computation server apparatuses includes:
a bit-decomposition operation part that performs a bit-decomposition in a constant number communication rounds for a share value secretly shared;
a table operation part that determines a success or failure of an equality at each bit of the bit-decomposition using a table in which determination expressions for determination whether or not the equality holds at each bit are arranged in a row direction, and combinations of the determination expressions are arranged in a column direction; and
an equality determination part that performs equality determination in a constant number communication rounds for a value that accumulates a result of the success or failure of the equality at each bit of the bit-decomposition to determine an array reference corresponding to the share value.

According to a second aspect of the present invention, there is provided a secure computation server apparatus that is one of at least three or more secure computation server apparatuses connected to each other through a network, including:

a bit-decomposition operation part that performs a bit-decomposition in a constant number communication rounds for a share value secretly shared;
a table operation part that determines a success or failure of an equality at each bit of the bit-decomposition using a table in which determination expressions for determination whether or not the equality holds at each bit are arranged in a row direction, and combinations of the determination expressions are arranged in a column direction; and
an equality determination part that performs equality determination in a constant number communication rounds for a value that accumulates a result of the success or failure of the equality at each bit of the bit-decomposition to determine an array reference corresponding to the share value.

According to a third aspect of the present invention, there is provided a secure computation method using at least three or more secure computation server apparatuses connected to each other through a network, including:

performing a bit-decomposition in a constant number communication rounds for a share value secretly shared;
determining a success or failure of an equality at each bit of the bit-decomposition using a table in which determination expressions for determination whether or not the equality holds at each bit are arranged in a row direction, and combinations of the determination expressions are arranged in a column direction; and
performing equality determination in a constant number communication rounds for a value that accumulates a result of the success or failure of the equality at each bit of the bit-decomposition to determine an array reference corresponding to the share value.

According to a fourth aspect of the present invention, there is provided a secure computation program that causes at least three or more secure computation server apparatuses connected to each other through a network to execute processes, including:

performing a bit-decomposition in a constant number communication rounds for a share value secretly shared;
determining a success or failure of an equality at each bit of the bit-decomposition using a table in which determination expressions for determination whether or not the equality holds at each bit are arranged in a row direction, and combinations of the determination expressions are arranged in a column direction; and
performing equality determination in a constant number communication rounds for a value that accumulates a result of the success or failure of the equality at each bit of the bit-decomposition to determine an array reference corresponding to the share value.

It is to be noted that this program can be recorded on a computer-readable storage medium. The storage medium can be non-transient one, such as a semiconductor memory, a hard disk, a magnetic recording medium, an optical recording medium, and so on. The present invention can be implemented as a computer program product.

### Advantageous Effects of Invention

According to each aspect of the present invention, there is provided a secure computation system, a secure computation server apparatus, a secure computation method, and a secret calculation program, which contribute to reducing the number of communication rounds.

### BRIEF DESCRIPTION OF THE DRAWINGS

FIG. 1 is a block diagram for illustrating an example of a functional configuration of a secure computation system;

FIG. 2 is a block diagram for illustrating an example of a functional configuration of a secure computation server apparatus

FIG. 3 is a flow chart for illustrating an example of operation regarding a Demux protocol;

FIG. 4 is a diagram illustrating an example of a hardware configuration of the secure computation server apparatus;

FIG. 5 illustrates an example of a decision tree;

FIG. 6 is a block diagram for illustrating an example of a functional configuration of a secure computation system;

FIG. 7 is a block diagram for illustrating an example of a functional configuration of a secure computation server apparatus;

FIG. 8 is a block diagram for illustrating an example of a functional configuration of a node element reference part;

FIG. 9 illustrates an example of an array reference of a node element;

FIG. 10 is a block diagram for illustrating an example of a functional configuration of a route computation part; and

FIG. 11 illustrates an example of a relationship between a route computation of a decision tree and a table.

### DESCRIPTION OF EMBODIMENTS

Hereinafter, example embodiments of the present invention will be described with reference to the drawings. However, the present invention is not limited to the example embodiments which will be described in the following. Also, it should be noted that the drawings are schematic drawings, and dimensional relationships of respective elements, ratios of respective elements etc. may be different from those in reality. Interactions between drawings may also include parts that have different mutual dimensional relationships and ratios.

### [Preparation]

Hereinafter, for explaining the present example embodiment, a notation will be defined and processing elements will be explained. The notation and an operation element(s) explained below will be commonly used in explanations of each example embodiment.

A share of x, which is linearly secret shared over a field, will be denoted by [x]. The secret shared share [x] is a shared data [x] shared and held by each of secure computation server apparatuses in a secure computation system described later. The secured value x can be decoded only when all these shared data [x]ᵢ are available.

The secure computation is a computation that performs processing that received a secret shared share as input while keeping the secured information secret. A Demux protocol is a processing that, for an input of [x] s.t. 0≤x<2^{k}, computes an output with only an array element corresponding to x is 1 and other elements are 0 as in a following expression, while keeping the data secret.

$$\begin{matrix}[ Math . 1 ] & \\ {\{ [ {b}_{j} ] \}}_{j = 0}^{{2}^{k} - 1} s . t . {b}_{j} = \{ \begin{matrix}1 & ( j = x ) \\ 0 & ( else )\end{matrix} & ( 1 )\end{matrix}$$

In addition, a protocol shown below is used as a building block (processing element(s)) in the example embodiment explaining below.

### [Equality Determination]

As an equality determination, a protocol is used to determine a success or failure of an equality with 0 in particular. As can be easily seen, it is also possible to determine the success or failure of the equality with a non-zero value by combining it with subtraction. This equality determination is expressed as follows.

$$\begin{matrix}[ Math . 2 ] & \\ [ b ] ← E Q Z ( [ x ] ) s . t . b = \{ \begin{matrix}1 & ( x = 0 ) \\ 0 & ( else )\end{matrix} & ( 2 )\end{matrix}$$

The method(s) described in NPL 2, for example, can be used as a concrete processing for the equality determination. In the equality determination described in NPL 2, the number of communication rounds is bounded by a constant number. However, as long as the number of communication rounds is a constant number, the use of any other appropriate processing(s) of the equality determination will not affect the effectiveness of the present invention.

### [Bit-Decomposition]

A bit-decomposition is a processing that outputs each digit in bit notation for an input of [x] s.t. 0≤x<2^{k}, as shown in a following expression.

$$\begin{matrix}[ Math . 3 ] & \\ {\{ [ {x}_{j} ] \}}_{j = 0}^{k - 1} ← B D ( [ x ] ) s . t . x = {\sum }_{j = 0}^{k - 1} {2}^{j} \cdot {x}_{j} & ( 3 )\end{matrix}$$

The method(s) described in NPL 2, for example, can be used as a concrete processing for the bit-decomposition. In the equality determination [sic. bit-decomposition] described in NPL 2, the number of communication rounds is bounded by a constant number. However, as long as the number of communication rounds is a constant number, the use of any other appropriate processing(s) of the bit-decomposition will not affect the effectiveness of the present invention.

### First Example Embodiment

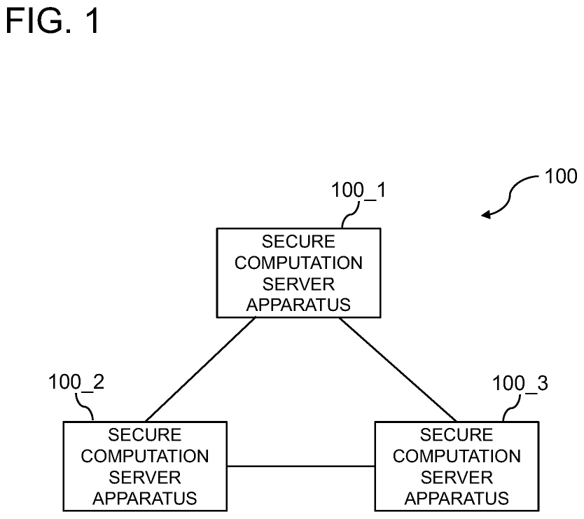

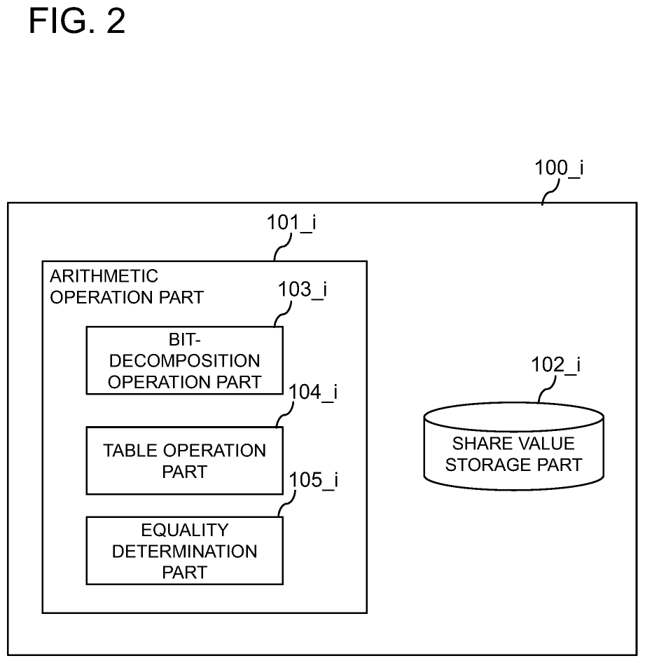

Hereinafter, referring to FIG. 1 and FIG. 2, description will proceed to a secure computation system and a secure computation server apparatus according to a first example embodiment of the present invention.

FIG. 1 is a block diagram for illustrating an example of a functional configuration of the secure computation system according to the first example embodiment. A secure computation system 100 according to the first example embodiment of the present invention is provided with a first secure computation server apparatus 100_1, a second secure computation server apparatus 100_2, and a third secure computation server apparatus 100_3, as illustrated in FIG. 1. Each of the first secure computation server apparatus 100_1, the second secure computation server apparatus 100_2, and the third secure computation server apparatus 100_3 is connected to communicate with each other through a network.

FIG. 2 is a block diagram for illustrating an example of a functional configuration of a secure computation server apparatus. A secure computation server apparatus 100_i (i=1, 2, 3) shown in FIG. 2 is an example of a functional configuration that is representative of the first secure computation server apparatus 100_1, the second secure computation server apparatus 100_2, and the third secure computation server apparatus 100_3.

As illustrated in FIG. 2, the secure computation server apparatus 100_i is provided with an arithmetic operation part 101_i, and a share value storage part 102_i. Further, the arithmetic operation part 101_i is provided with a bit-decomposition operation part 103_i, a table operation part 104_i, and an equality determination part 105_i. The arithmetic operation part 101_i, the share value storage part 102_i, the bit-decomposition operation part 103_i, the table operation part 104_i, and the equality determination part 105_i can also be realized by a processor executing a program stored in a memory by means of a hardware configuration illustrated below.

In the secure computation system 100, provided with the first to the third secure computation server apparatuses 100_i (i=1, 2, 3) of above configuration, for a value inputted by any one of the secure computation server apparatus 100_i among the first to the third secure computation server apparatuses 100_i (i=1, 2, 3), a target share is computed, without being known of the value inputted and a value(s) of computation process and the target share is stored in each of the share value storage part 102_i of the first to the third secure computation server apparatuses 100_i (i=1, 2, 3), respectively.

In addition, in the secure computation system 100, provided with the first to the third secure computation server apparatuses 100_i (i=1, 2, 3) of above configuration, for a share stored in each of the share value storage parts 102_i of the first to the third secure computation server apparatuses 100_i (i=1, 2, 3), a target share is computed, without being known of a value(s) of computation processes, and the target share is stored in each of the share value storage part 102_i of the first to the third secure computation server apparatuses 100_i (i=1, 2, 3), respectively.

It is noted that the share of the above computation result may be restored by transmitting and receiving the share among the first to the third secure computation server apparatuses 100_1 to 100_3. Alternatively, the share may be decoded by transmitting the share to an outside other than the first to the third secure computation server apparatuses 100_1 to 100_3.

The bit-decomposition operation part 103_i performs a bit-decomposition in a constant number communication rounds for a secret shared share value. The table operation part 104_i determines a success or failure of an equality at each bit of the result of the bit-decomposition by the bit-decomposition operation part 103_i, using a table in which determination expressions for determination whether or not the equality holds at each bit are arranged in a row direction and combinations of the determination expressions are arranged in a column direction. Since the success or failure of the equality at each bit can be determined by an arithmetic XOR and an arithmetic NOT, the number of communication rounds is bounded by a constant number. The equality determination part 105_i performs equality determination in the constant number communication rounds for a value accumulated a result of the success or failure of the equality at each bit of the bit-decomposition to determine an array reference corresponding to the inputted share value.

Here, the arithmetic XOR is a processing that computes [x xor y] for shares [x] and [y]. Note that since x and y have one bit each, their values are 0 or 1 and the equation ([x]−[y])²=[x xor y] is valid. Therefore, the arithmetic XOR corresponds to a processing of computing a square of a difference. On the other hand, the arithmetic NOT is a processing that computes [x xor 1] for shares [x] and the equation ([x]−1)²=[x xor 1] is valid. Therefore, the arithmetic NOT corresponds to a processing of computing a square of input minus 1.

Using these properties, 1 bit equality determination can be performed as follows. In a processing that computes [x?=y] for shares [x] and[y], (([x]−[y])²−1)² may be computed. In other words, the arithmetic XOR is performed on [x] and [y], and the arithmetic NOT is performed on the result. For example, if x=y, the result of performing the arithmetic XOR on [x] and [y] will be [0], and then [1] will be output by the arithmetic NOT performed subsequently on the result. On the other hand, if x≠y, the result of performing the arithmetic XOR on [x] and [y] will be [1], and then [0] will be output by the arithmetic NOT performed subsequently on the result.

As described above, the bit-decomposition operation part 103_i, the table operation part 104_i, and the equality determination part 105_i perform a processing that the number of communication rounds is bounded by a constant number, respectively, therefore, in a whole processing of Demux protocol, the number of communication rounds can be bounded by a constant number. That is, the secure computation system 100 and the secure computation server apparatuses 100_i (i=1, 2, 3) of above configuration can contribute to reducing the number of communication rounds in Demux protocol and can reduce a communication cost in an environment with large communication latency.

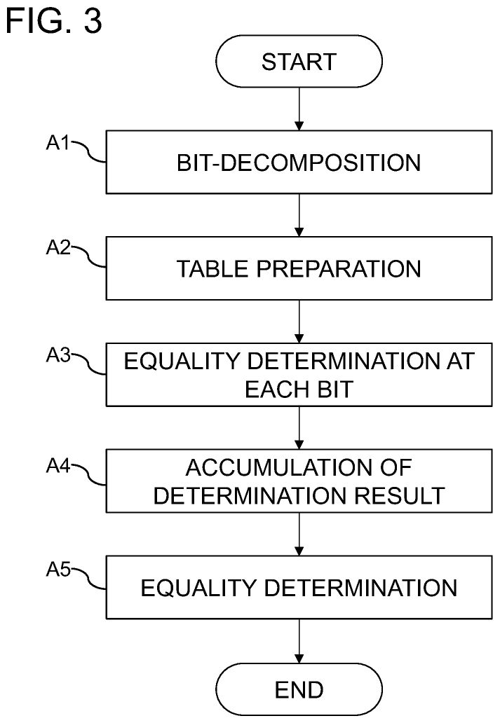

Next, a secure computation method according to the first example embodiment of the present invention will be described in detail. That is, an operation of the secure computation system 100 provided with the first to the third secure computation server apparatuses 100_i (i=1, 2, 3), as described above, will be described. FIG. 3 is a flow chart for illustrating an example of operation related to the Demux protocol. Each step is described below.

### (Step A1)

The first to the third secure computation server apparatuses 100_i (i=1, 2, 3) in the secure computation system 100 perform a bit-decomposition in a constant number communication rounds for the secret shared share value. Here, the secret shared share value may be a share value that computed based on information inputted from outside the secure computation system 100, or it may be a share value already secretly shared and stored in the share value storage part 102_i in each of the first to the third secure computation server apparatuses 100_i (i=1, 2, 3).

As a concrete processing for the bit-decomposition, it can be appropriately chosen among processings where the number of communication rounds is bounded by a constant number, for example, the bit-decomposition of the building block as described above can be used.

### (Step A2)

Each of the first to the third secure computation server apparatuses 100_i (i=1, 2, 3) in the secure computation system 100 prepares a table in which determination expressions for determination whether or not the equality holds at each bit are arranged in a row direction and combinations of the determination expressions are arranged in a column direction. The table to be prepared here may be stored in the storage device in each of the first to the third secure computation server apparatuses 100_i (i=1, 2, 3) in advance, or it may be created in response to the input in step A1.

The concrete form of the table used in this step A2 can be illustrated as follows. Note that “?=” in each element of the table below means to determine whether or not the equality holds. As the determination result, 1 is output when the equality holds, and 0 is output when the equality does not hold. As already pointed out, the success or failure of the equality at each bit can be determined by the arithmetic XOR and the arithmetic NOT.

TABLE 1

| | k-1 | k-2 | k-3 | | 2 | 1 | 0 |
|---|---|---|---|---|---|---|---|
| 0 | [xₖ₋₁ ? = 0] | [xₖ₋₁ ? = 0] | [xₖ₋₁ ? = 0] | . . . | [x₂ ? = 0] | [x₁ ? = 0] | [x₀ ? = 0] |
| 1 | [xₖ₋₁ ? = 0] | [xₖ₋₁ ? = 0] | [xₖ₋₁ ? = 0] | . . . | [x₂ ? = 0] | [x₁ ? = 0] | [x₀ ? = 1] |
| 2 | [xₖ₋₁ ? = 0] | [xₖ₋₁ ? = 0] | [xₖ₋₁ ? = 0] | . . . | [x₂ ? = 0] | [x₁ ? = 1] | [x₀ ? = 0] |
| 3 | [xₖ₋₁ ? = 0] | [xₖ₋₁ ? = 0] | [xₖ₋₁ ? = 0] | . . . | [x₂ ? = 0] | [x₁ ? = 1] | [x₀ ? = 1] |
| | . | . | . | | . | . | . |
| | . | . | . | | . | . | . |
| | . | . | . | | . | . | . |
| 2^{k}-2 | [xₖ₋₁ ? = 1] | [xₖ₋₁ ? = 1] | [xₖ₋₁ ? = 1] | . . . | [x₂ ? = 1] | [x₁ ? = 1] | [x₀ ? = 0] |
| 2^{k}-1 | [xₖ₋₁ ? = 1] | [xₖ₋₁ ? = 1] | [xₖ₋₁ ? = 1] | . . . | [x₂ ? = 1] | [x₁ ? = 1] | [x₀ ? = 1] |

In the above table, the determination expressions for determination whether or not the equality holds at each bit of the result of the bit-decomposition by the above expression (3) are arranged in a row direction. For example, when all the bits in the result of the bit-decomposition by expression (3) are 0, the outputs of all the determination expressions in the 0th row will be 1. Since the input for the bit-decomposition is [x] s.t. 0≤x<2^{k}, there are 2^{k} combinations of determination expressions, and when the input is [x], only for the xth row, the outputs of all the determination expressions will be 1.

### (Step A3)

The table operation part 104_i uses such a table to determine the success or failure of the equality at each bit of the result of the bit-decomposition by the bit-decomposition operation part 103_i. The determination result of the success or failure of the equality at each bit is output as an array (i.e., vector) in a column direction. This vector is denoted as rowⱼ (0≤j<2^{k}).

### (Step A4)

The first to the third secure computation server apparatuses 100_i (i=1, 2, 3) in the secure computation system 100 accumulate a result of the success or failure of the equality at each bit of the bit-decomposition. Concretely, the first to the third secure computation server apparatuses 100_i (i=1, 2, 3) in the secure computation system 100 accumulate them by computing an inner product for rows (0≤j<2^{k}) of the result of step A2 and (1, . . . , 1). It is possible to accumulate the number of 1 included in rowⱼ by computing an inner product with the vector (1, . . . , 1). The first to the third secure computation server apparatuses 100_i (i=1, 2, 3) in the secure computation system 100 compute this inner product for all the “j” satisfied 0≤j<2^{k} and set the result as [resⱼ]. Note that in this inner product computation, the number of communication rounds is bounded by a constant number.

[Math. 4]

[resⱼ]←InnerProduct(1=(1, . . . ,1),rowⱼ) for j=0, . . . ,2^{k}−1 (4)

### (Step A5)

The first to the third secure computation server apparatuses 100_i (i=1, 2, 3) in the secure computation system 100 perform the equality determination for an accumulated value in the constant number communication rounds as described above to determine an array reference corresponding to the inputted share value. As a concrete processing for the equality determination, it can be appropriately chosen among processings where the number of communication rounds is bounded by a constant number, for example, the equality determination of the building block as described above can be used. In other words, by performing an equality determination according to the expression below, an array bⱼ, in which only the xth bit is 1 and all other bits are 0, can be obtained.

Return {[bⱼ]←EQZ([resⱼ]−k)}ⱼ₌₀^{k-1} [Math. 5]

In the above secure computation method, the first to the third secure computation server apparatuses 100_i (i=1, 2, 3) in the secure computation system 100 perform a processing that the number of communication rounds is bounded by a constant number in all the steps, respectively, therefore, in a whole processing of Demux protocol, the number of communication rounds can be bounded by a constant number. That is, the above secure computation method can contribute to reducing the number of communication rounds in Demux protocol and can reduce a communication cost in an environment with large communication latency.

### [Hardware Configuration Example]

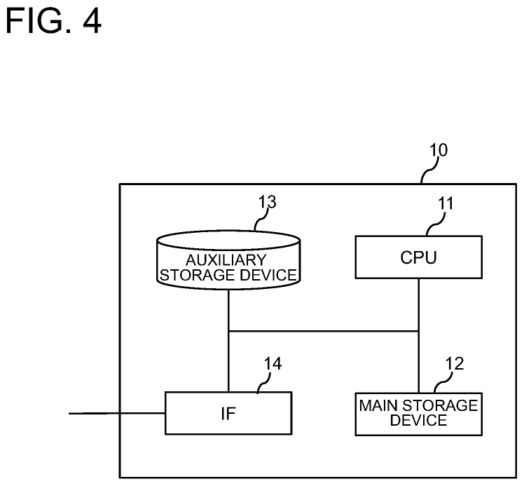

FIG. 4 is a diagram illustrating an example of a hardware configuration of the secure computation server apparatus. That is, the hardware configuration illustrated in FIG. 4 is an example of the hardware configuration of each of the secure computation server apparatuses 100_i, 200_i (i=1, 2, 3). An information processing apparatus (computer) employing the hardware configuration illustrated in FIG. 4 can realize each function of the secure computation server apparatuses 100_i, 200_i by executing the secure computation method described above as a program.

It should be noted that the hardware configuration illustrated in FIG. 4 is one example of a hardware configuration realizing each function of the secure computation server apparatuses 100_i, 200_i (i=1, 2, 3), and is not intended to limit the hardware configuration of the secure computation server apparatuses 100_i, 200_i (i=1, 2, 3). The secure computation server apparatuses 100_i, 200_i (i=1, 2, 3) may include hardware not illustrated in FIG. 4.

The hardware configuration 10 that can be employed by the secure computation server apparatuses 100_i, 200_i (i=1, 2, 3) is provided with a CPU (Central Processing Unit) 11, a main storage device 12, an auxiliary storage device 13 and an IF (Interface) part 14, which are interconnected by an internal bus, as illustrated in FIG. 4.

CPU 11 executes each instruction included in a secret calculation program executed by the secure computation server apparatuses 100_i, 200_i (i=1, 2, 3). The main storage device 12 has, for example, a RAM (Random Access Memory), and temporarily stores various programs such as the secret calculation program executed by the secure computation server apparatuses 100_i, 200_i (i=1, 2, 3) for processing by the CPU 11.

The auxiliary storage device 13 has, for example, a HDD (Hard Disk Drive), and can store various programs such as the secure computation program executed by the secure computation server apparatuses 100_i, 200_i (i=1, 2, 3) in mid and long term. The various programs such as the secure computation program may provide as a program product recorded in a non-transitory computer readable storage medium. The auxiliary storage device 13 can be used to store various programs such as the secure computation program recorded in the non-transitory computer readable storage medium in mid and long term.

The IF part 14 provides an interface for an input/output between the secure computation server apparatuses 100_i, 200_i (i=1, 2, 3). The IF part 14 may connect to a network with large communication latency, such as WAN (Wide Area Network).

An information processing apparatus employing the hardware configuration illustrated above can realize each function of the secure computation server apparatuses 100_i, 200_i (i=1, 2, 3) by executing the secure computation method described above as a program.

### Second Example Embodiment

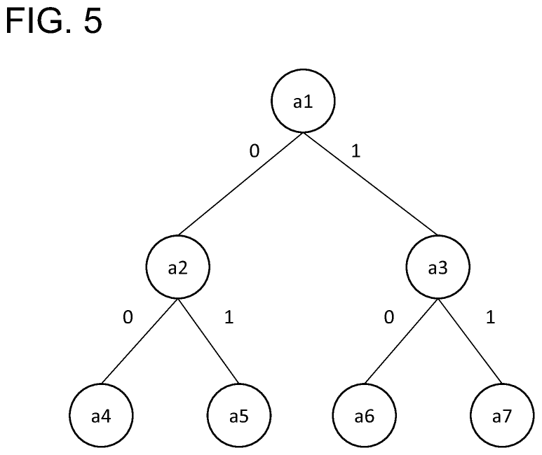

Hereinafter, referring to FIGS. 5, through 11, description will proceed to a secure computation system and a secure computation server apparatus according to a second example embodiment of the present invention. The secure computation system and the secure computation server apparatus according to the second example embodiment of the present invention is an embodiment in which an implementation of the present invention is applied to a computation of a decision tree as illustrated in FIG. 5.

As illustrated in FIG. 5, the decision tree has nodes and branches. The computation using the decision tree includes a processing that refers an element used for a determination at the nodes, a processing that determines a branch(es) at each node, and a processing that computes a route of how each branch was traced. In the computation of decision tree using the secure computation, all of these computations are performed in secret.

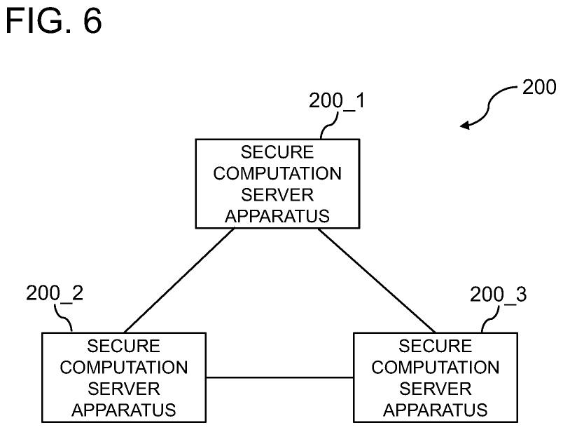

FIG. 6 is a block diagram for illustrating an example of a functional configuration of the secure computation system according to the second example embodiment. A secure computation system 200 according to the second example embodiment of the present invention is provided with a first secure computation server apparatus 200_1, a second secure computation server apparatus 200_2, and a third secure computation server apparatus 200_3, as illustrated in FIG. 6. Each of the first secure computation server apparatus 200_1, the second secure computation server apparatus 200_2, and the third secure computation server apparatus 200_3 is connected to communicate with each other through a network.

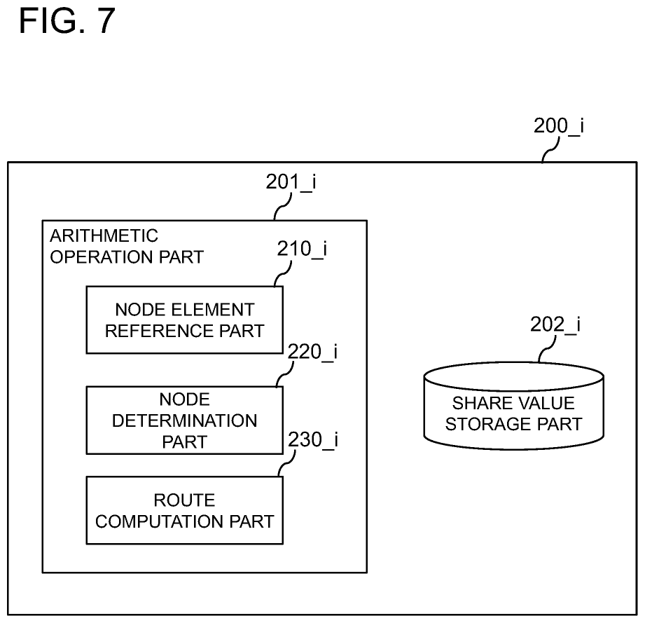

FIG. 7 is a block diagram for illustrating an example of a functional configuration of the secure computation server apparatus. A secure computation server apparatus 200_i (i=1, 2, 3) shown in FIG. 7 is an example of a functional configuration that is representative of the first secure computation server apparatus 200_1, the second secure computation server apparatus 200_2, and the third secure computation server apparatus 200_3.

As illustrated in FIG. 7, the secure computation server apparatus 200_i is provided with an arithmetic operation part 201_i, and a share value storage part 202_i. Further, the arithmetic operation part 201_i is provided with a node element reference part 210_i, a node determination part 220_i, and a route computation part 230_i. The arithmetic operation part 201_i, the share value storage part 202_i, the node element reference part 210_i, the node determination part 220_i, and the route computation part 230_i can also be realized by a processor executing a program stored in a memory by means of the aforementioned hardware configuration.

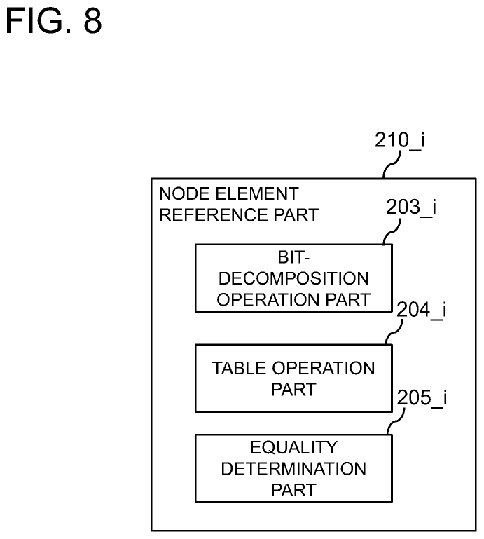

FIG. 8 is a block diagram for illustrating an example of a functional configuration of the node element reference part. As illustrated in FIG. 5, the node element reference part 210_i is provided with a bit-decomposition operation part 203_i, a table operation part 204_i, and an equality determination part 205_i. The bit-decomposition operation part 203_i, the table operation part 204_i, and the equality determination part 205_i can also be realized by a processor executing a program stored in a memory by means of the aforementioned hardware configuration.

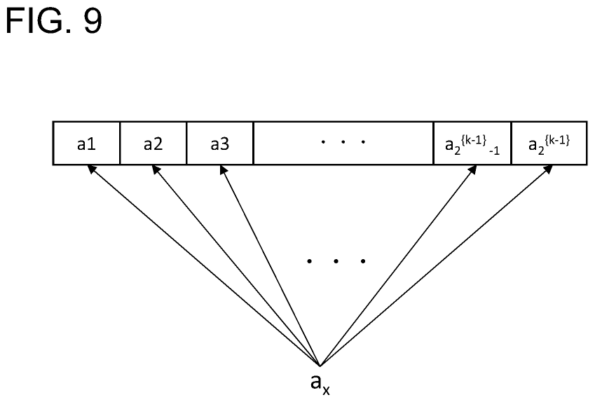

As illustrated in FIG. 5, the computation using the decision tree uses elements a1, . . . , a₂^{{k-1}} for determination at each node. These elements a1, . . . , a₂^{{k-1}} are arrayed and stored in the share value storage part 202_i as shown in FIG. 9. Therefore, in the computation using the decision tree, it is necessary to perform an array reference to the elements a1, . . . , a₂^{{k-1}}. The Demux protocol, explained in the first example embodiment, can be used for this array reference.

In other words, the bit-decomposition operation part 203_i performs a bit-decomposition for an index x of the element aₓ in the constant number communication rounds. The table operation part 204_i determines a success or failure of an equality at each bit of the result of the bit-decomposition by the bit-decomposition operation part 203_i, using a table in which determination expressions for determination whether or not the equality holds at each bit are arranged in a row direction and combinations of the determination expressions are arranged in a column direction. Then, the equality determination part 205_i performs an equality determination in the constant number communication rounds for a value accumulated a result of the success or failure of the equality at each bit of the bit-decomposition to determine array reference corresponding to the index x of the element aₓ.

Note that, the node determination part 220_i determines which branch the element aₓ obtained by the node element reference part 210_i proceeds to. However, this processing can be performed by a processing in which the number of communication rounds is bounded by a constant number by using a known processing, such as the processing described in NPL 2.

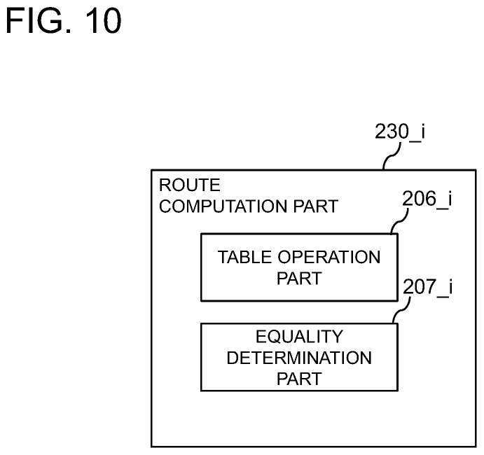

FIG. 10 is a block diagram for illustrating an example of a functional configuration of the route computation part. As illustrated in FIG. 10, the route computation part 230_i is provided with a table operation part 206_i and an equality determination part 207_i. The table operation part 206_i and the equality determination part 207_i can also be realized by a processor executing a program stored in a memory by means of the aforementioned hardware configuration.

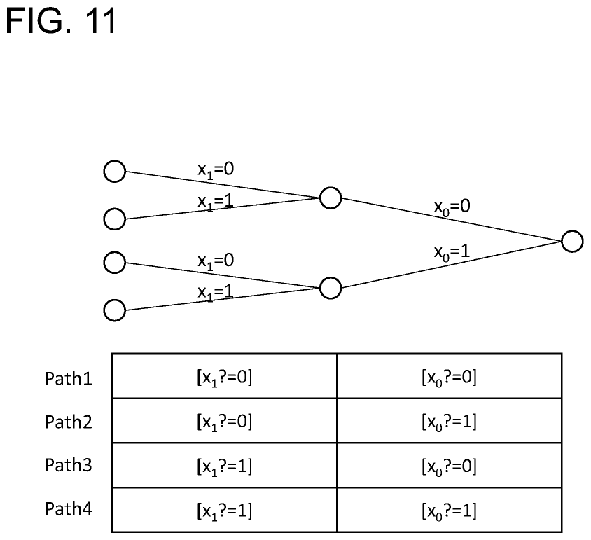

The route computation part 230_i performs a route computation using a table as shown in FIG. 11. FIG. 11 illustrates a relationship between the route computation of the decision tree and the table. As shown in FIG. 11, if a branch determination is expressed in bits and a depth of the decision tree is considered to be a digit of the bit-decomposition, the route of the decision tree that branches at each node can be a table similar to that explained in the first example embodiment. In other words, the table that the route computation part 230_i uses for performing the route computation is a table in which determination expressions for determination whether or not the equality holds at each bit are arranged in a row direction and combinations of the determination expressions are arranged in a column direction.

Therefore, the table operation part 206_i and the equality determination part 207_i can perform the route computation using the table as in the first example embodiment. The output of the route computation part 230_i is the result of the computation using the decision tree and is an array reference that points to the result of a determination or an analysis made using the decision tree.

As described above, the node element reference part 210_i, the node determination part 220_i, and the route computation part 230_i perform processing that the number of communication rounds is bounded by a constant number, respectively, therefore, in a whole processing of using the decision tree, the number of communication rounds can be bounded by a constant number. That is, the secure computation system 100 and the secure computation server apparatuses 100_i (i=1, 2, 3) of above configuration can contribute to reducing the number of communication rounds in a whole processing of using the decision tree and can reduce a communication cost in environments with large communication latency.

A part or a whole of the above-mentioned example embodiments may be described as, but not limited to, the following supplementary notes.

### [Supplementary Note 1]

A secure computation system, including at least three or more secure computation server apparatuses connected to each other through a network, wherein

each of the secure computation server apparatuses includes:
a bit-decomposition operation part that performs a bit-decomposition in a constant number communication rounds for a share value secretly shared;
a table operation part that determines a success or failure of an equality at each bit of the bit-decomposition using a table in which determination expressions for determination whether or not the equality holds at each bit are arranged in a row direction, and combinations of the determination expressions are arranged in a column direction; and
an equality determination part that performs equality determination in a constant number communication rounds for a value that accumulates a result of the success or failure of the equality at each bit of the bit-decomposition to determine an array reference corresponding to the share value.

### [Supplementary Note 2]

The secure computation system described in the supplementary note 1, wherein

the value that accumulates the result of the success or failure of the equality at each bit of the bit-decomposition is obtained by computing an inner product for the result of the success or failure of the equality at each bit of the bit-decomposition and (1, . . . , 1).

### [Supplementary Note 3]

The secure computation system described in the supplementary note 1 or 2, wherein

the equality determination part repeatedly performs equality determination on a candidate of the array reference to determine the array reference.

### [Supplementary Note 4]

The secure computation system described in any one of supplementary notes 1 to 3, wherein

the determination expressions in the table provide expressions that when the share value secretly shared is [x], only for the xth row, outputs of all the determination expressions are 1.

### [Supplementary Note 5]

The secure computation system described in any one of supplementary notes 1 to 4, wherein

the table relates to a determination expression for a bit-decomposition of an input in Demux protocol.

### [Supplementary Note 6]

The secure computation system described in any one of supplementary notes 1 to 4, wherein

the table relates to a determination expression for a bit-decomposition of an index of an element, the element being used for determination at a node of a decision tree.

### [Supplementary Note 7]

The secure computation system described in any one of supplementary notes 1 to 4, wherein

the table relates to a determination expression(s) for a branch(es) of a decision tree.

### [Supplementary Note 8]

A secure computation server apparatus that is one of at least three or more secure computation server apparatuses connected to each other through a network, including:

a bit-decomposition operation part that performs a bit-decomposition in a constant number communication rounds for a share value secretly shared;
a table operation part that determines a success or failure of an equality at each bit of the bit-decomposition using a table in which determination expressions for determination whether or not the equality holds at each bit are arranged in a row direction, and combinations of the determination expressions are arranged in a column direction; and
an equality determination part that performs equality determination in a constant number communication rounds for a value that accumulates a result of the success or failure of the equality at each bit of the bit-decomposition to determine an array reference corresponding to the share value.

### [Supplementary Note 9]

A secure computation method using at least three or more secure computation server apparatuses connected to each other through a network, including:

performing a bit-decomposition in a constant number communication rounds for a share value secretly shared;
determining a success or failure of an equality at each bit of the bit-decomposition using a table in which determination expressions for determination whether or not the equality holds at each bit are arranged in a row direction, and combinations of the determination expressions are arranged in a column direction; and
performing equality determination in a constant number communication rounds for a value that accumulates a result of the success or failure of the equality at each bit of the bit-decomposition to determine an array reference corresponding to the share value.

### [Supplementary Note 10]

A secure computation program that causes at least three or more secure computation server apparatuses connected to each other through a network to execute processes, including:

performing a bit-decomposition in a constant number communication rounds for a share value secretly shared;
determining a success or failure of an equality at each bit of the bit-decomposition using a table in which determination expressions for determination whether or not the equality holds at each bit are arranged in a row direction, and combinations of the determination expressions are arranged in a column direction; and
performing equality determination in a constant number communication rounds for a value that accumulates a result of the success or failure of the equality at each bit of the bit-decomposition to determine an array reference corresponding to the share value.

It should be noted that, each disclosure of the NPLs cited above is incorporated herein by reference thereto. It is to be noted that it is possible to modify or adjust the example embodiments or examples within the whole disclosure of the present invention (including the Claims) and based on the basic technical concept thereof. Further, it is possible to variously combine or select (or partially delete) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

100,200 secure computation system
100_i,200_i secure computation server apparatus
101_i,201_i arithmetic operation part
102_i,202_i share value storage part
103_i,203_i bit-decomposition operation part
104_i,204_i,206_i table operation part
105_i,205_i,207_i equality determination part

What is claimed is:

1. A secure computation system, comprising at least three or more secure computation server apparatuses connected to each other through a network, wherein
each of the secure computation server apparatuses comprises:
a bit-decomposition operation part that performs a bit-decomposition in a constant number communication rounds for a share value secretly shared;
a table operation part that determines a success or failure of an equality at each bit of the bit-decomposition using a table in which determination expressions for determination whether or not the equality holds at each bit are arranged in a row direction, and combinations of the determination expressions are arranged in a column direction; and
an equality determination part that performs equality determination in a constant number communication rounds for a value that accumulates a result of the success or failure of the equality at each bit of the bit-decomposition to determine an array reference corresponding to the share value.

2. The secure computation system according to claim 1, wherein
the value that accumulates the result of the success or failure of the equality at each bit of the bit-decomposition is obtained by computing an inner product for the result of the success or failure of the equality at each bit of the bit-decomposition and (1, . . . , 1).

3. The secure computation system according to claim 1, wherein
the equality determination part repeatedly performs equality determination on a candidate of the array reference to determine the array reference.

4. The secure computation system according to claim 1, wherein
the determination expressions in the table provide expressions that when the share value secretly shared is [x], only for the xth row, outputs of all the determination expressions are 1.

5. The secure computation system according to claim 1, wherein
the table relates to a determination expression for a bit-decomposition of an input in Demux protocol.

6. The secure computation system according to claim 1, wherein
the table relates to a determination expression for a bit-decomposition of an index of an element, the element being used for determination at a node of a decision tree.

7. The secure computation system according to claim 1, wherein
the table relates to a determination expression(s) for a branch(es) of a decision tree.

8. A secure computation server apparatus that is one of at least three or more secure computation server apparatuses connected to each other through a network, comprising:
a bit-decomposition operation part that performs a bit-decomposition in a constant number communication rounds for a share value secretly shared;
a table operation part that determines a success or failure of an equality at each bit of the bit-decomposition using a table in which determination expressions for determination whether or not the equality holds at each bit are arranged in a row direction, and combinations of the determination expressions are arranged in a column direction; and
an equality determination part that performs equality determination in a constant number communication rounds for a value that accumulates a result of the success or failure of the equality at each bit of the bit-decomposition to determine an array reference corresponding to the share value.

9. A secure computation method using at least three or more secure computation server apparatuses connected to each other through a network, comprising:
performing a bit-decomposition in a constant number communication rounds for a share value secretly shared;
determining a success or failure of an equality at each bit of the bit-decomposition using a table in which determination expressions for determination whether or not the equality holds at each bit are arranged in a row direction, and combinations of the determination expressions are arranged in a column direction; and
performing equality determination in a constant number communication rounds for a value that accumulates a result of the success or failure of the equality at each bit of the bit-decomposition to determine an array reference corresponding to the share value.

10. A non-transient computer readable medium storing a secure computation program that causes at least three or more secure computation server apparatuses connected to each other through a network to execute processes, comprising:
performing a bit-decomposition in a constant number communication rounds for a share value secretly shared;
determining a success or failure of an equality at each bit of the bit-decomposition using a table in which determination expressions for determination whether or not the equality holds at each bit are arranged in a row direction, and combinations of the determination expressions are arranged in a column direction; and
performing equality determination in a constant number communication rounds for a value that accumulates a result of the success or failure of the equality at each bit of the bit-decomposition to determine an array reference corresponding to the share value.

11. The secure computation server apparatus according to claim 8, wherein
the value that accumulates the result of the success or failure of the equality at each bit of the bit-decomposition is obtained by computing an inner product for the result of the success or failure of the equality at each bit of the bit-decomposition and (1, . . . , 1).

12. The secure computation server apparatus according to claim 8, wherein
the equality determination part repeatedly performs equality determination on a candidate of the array reference to determine the array reference.

13. The secure computation server apparatus according to claim 8, wherein
the determination expressions in the table provide expressions that when the share value secretly shared is [x], only for the xth row, outputs of all the determination expressions are 1.

14. The secure computation server apparatus according to claim 8, wherein
the table relates to a determination expression for a bit-decomposition of an index of an element, the element being used for determination at a node of a decision tree.

15. The secure computation method according to claim 9, wherein
the value that accumulates the result of the success or failure of the equality at each bit of the bit-decomposition is obtained by computing an inner product for the result of the success or failure of the equality at each bit of the bit-decomposition and (1, . . . , 1).

16. The secure computation method according to claim 9, wherein
the equality determination repeatedly performs equality determination on a candidate of the array reference to determine the array reference.

17. The secure computation method according to claim 9, wherein
the determination expressions in the table provide expressions that when the share value secretly shared is [x], only for the xth row, outputs of all the determination expressions are 1.

18. The non-transient computer readable medium storing a secure computation program according to claim 10, wherein
the value that accumulates the result of the success or failure of the equality at each bit of the bit-decomposition is obtained by computing an inner product for the result of the success or failure of the equality at each bit of the bit-decomposition and (1, . . . , 1).

19. The non-transient computer readable medium storing a secure computation program according to claim 10, wherein
the equality determination repeatedly performs equality determination on a candidate of the array reference to determine the array reference.

20. The non-transient computer readable medium storing a secure computation program according to claim 10, wherein
the determination expressions in the table provide expressions that when the share value secretly shared is [x], only for the xth row, outputs of all the determination expressions are 1.
